(19) United States
(12) Patent Application Publication
(10) Pub. No.: US 2023/0004461 A1
(43) Pub. Date: Jan. 5, 2023

(54) SYSTEMS AND METHODS FOR USING PATTERN-BASED BIT FLIPS FOR FASTER WRITE AND CONSISTENT ERROR RECOVERY

(71) Applicant: Dell Products L.P., Round Rock, TX (US)

(72) Inventors: Shekar Babu SURYANARAYANA, Bangalore (IN); Anand P. JOSHI, Round Rock, TX (US)

(73) Assignee: Dell Products L.P., Round Rock, TX (US)

(21) Appl. No.: 17/366,955

(22) Filed: Jul. 2, 2021

(51) Int. Cl. G06F 11/10; G06F 11/14

(52) U.S. Cl. CPC G06F 11/1068; G06F 11/1417; G06F 2201/82; G06F 8/71

(57) ABSTRACT

An information handling system may include a processor and a non-transitory computer-readable medium having stored thereon a program of instructions executable by the processor, the program of instructions configured to, when read and executed by the processor, receive a write request to a non-volatile memory, combine write request data and data patterns associated with the write request into a versioned log and store the versioned log in a persistent memory, and store in the persistent memory patterned-matched bits for single- and multi-bit error recovery code-based recovery.

### TECHNICAL FIELD

The present disclosure relates in general to information handling systems, and more particularly to methods and systems for using pattern-based bit flips for faster writes to a storage resource and for consistent error recovery for the storage resource.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

NAND flash technology has enabled information handling systems to provide rich functionalities and is used in a variety of operating system and platform firmware data stores. However, NAND technology does include some disadvantages, such as asymmetric speed of read and write operations, inability to perform in-place updates, limited lifetime, random page write prohibition within a block, and others. Accordingly, an operating system (OS) system management mode (SMM) or runtime services-based write to non-volatile random access memory (NVRAM) implemented using NAND flash may be costly due to the asymmetric read/write access.

Such disadvantages may also lead to other problems, including NVRAM data corruptions due to power failure during firmware update that may be caused due to slower writes, parity mismatch with previous data patterns and current data patterns, and/or other reasons.

Further, NAND flash architectures suffer from a phenomenon known as bit flipping. Bit flipping may occur due to natural wear and aging on memory cells, and may be exacerbated by ambient electromagnetic radiation. An error correction code (ECC) algorithm is often applied to correct bit flips, but during a power failure, the ECC algorithm may fail to correct bit flips, and thus corrupted data may be accessed from the NVRAM, resulting in boot failures.

Accordingly, NVRAM write failures due to single- or multi-bit errors during power failure may be disastrous and recovery of data corruption may be difficult. While hamming code algorithms exist to recover single-bit ECC errors during normal write cycles, none may exist to recover bit corruptions in the failure scenarios described above. Data spread across multiple words and write failure may lead to multiple parity mismatches, with no logging or error detection, further rendering recovery difficult.

### SUMMARY

In accordance with the teachings of the present disclosure, the disadvantages and problems associated with existing approaches to writing data to a storage resource in an information handling system may be reduced or eliminated.

In accordance with embodiments of the present disclosure, an information handling system may include a processor and a non-transitory computer-readable medium having stored thereon a program of instructions executable by the processor, the program of instructions configured to, when read and executed by the processor, receive a write request to a non-volatile memory, combine write request data and data patterns associated with the write request into a versioned log and store the versioned log in a persistent memory, and store in the persistent memory patterned-matched bits for single- and multi-bit error recovery code-based recovery.

In accordance with these and other embodiments of the present disclosure, a method may include receiving a write request to a non-volatile memory of an information handling system, combining write request data and data patterns associated with the write request into a versioned log and storing the versioned log in a persistent memory, and storing in the persistent memory patterned-matched bits for single- and multi-bit error recovery code-based recovery.

In accordance with these and other embodiments of the present disclosure, an article of manufacture may include a non-transitory computer-readable medium and computer-executable instructions carried on the computer readable medium, the instructions readable by a processor, the instructions, when read and executed, for causing the processor to receive a write request to a non-volatile memory of an information handling system; combine write request data and data patterns associated with the write request into a versioned log and store the versioned log in a persistent memory; and store in the persistent memory patterned-matched bits for single- and multi-bit error recovery code-based recovery.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a diagram depicting functionality of a write combined error correction and translation driver, in accordance with embodiments of the present disclosure; and

FIG. 3 illustrates a diagram depicting a hybrid cache, in accordance with embodiments of the present disclosure.

### DETAILED DESCRIPTION

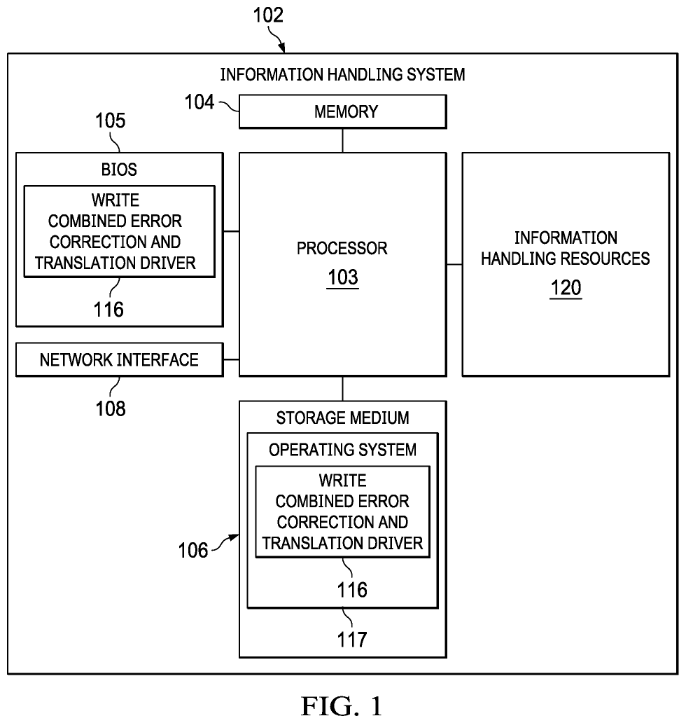

Preferred embodiments and their advantages are best understood by reference to FIGS. 1 through 3, wherein like numbers are used to indicate like and corresponding parts. For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

FIG. 1 illustrates a block diagram of an example information handling system 102, in accordance with embodiments of the present disclosure. In some embodiments, information handling system 102 may comprise a server. In other embodiments, information handling system 102 may be a personal computer (e.g., a desktop computer, a laptop, notebook, tablet, handheld, smart phone, personal digital assistant, etc.). As depicted in FIG. 1, information handling system 102 may include a processor 103, a memory 104 communicatively coupled to processor 103, a storage medium 106 communicatively coupled to processor 103, a basic input/output system (BIOS) 105 communicatively coupled to processor 103, a network interface 108 communicatively coupled to processor 103, and one or more other information handling resources 120 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, storage medium 106, BIOS 105, and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

Storage medium 106 may be communicatively coupled to processor 103 and may include any system, device, or apparatus operable to store information processed by processor 103. Storage medium 106 may include, for example, network attached storage, one or more direct access storage devices (e.g., hard disk drives), and/or one or more sequential access storage devices (e.g., tape drives).

As shown in FIG. 1, storage medium 106 may have stored thereon an operating system (OS) 114. OS 114 may be any program of executable instructions, or aggregation of programs of executable instructions, configured to manage and/or control the allocation and usage of hardware resources such as memory, CPU time, disk space, and input and output devices, and provide an interface between such hardware resources and application programs hosted by OS 114. Active portions of OS 114 may be transferred to memory 104 for execution by processor 103. As shown in FIG. 1, OS 114 may include or implement a write combined error correction and translation driver 116, which may be referred to herein as “driver 116.”

Driver 116 may comprise a program of instructions configured to, when loaded into memory 104 and executed by processor 103, provide a software interface to an NVRAM used to store BIOS firmware (e.g., for storing BIOS 105) or other firmware of information handling system 102. Thus, driver 116 may enable OS 114 or other applications executing on information handling system 102 to access hardware functions of the NVRAM without needing to be aware of precise details about the NVRAM hardware being used.

BIOS 105 may be communicatively coupled to processor 103 and may include any system, device, or apparatus configured to identify, test, and/or initialize information handling resources of information handling system 102. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105. In these and other embodiments, BIOS 105 may comprise boot firmware configured to be the first code executed by processor 103 when information handling system 102 is booted and/or powered on. As part of its initialization functionality, code for BIOS 105 may be configured to set components of information handling system 102 into a known state, so that one or more applications (e.g., operating system 114 or other application programs) stored on compatible media (e.g., memory 104, storage medium 106) may be executed by processor 103 and given control of information handling system 102. In particular embodiments, BIOS 105 may be implemented as and/or stored in NVRAM implemented using NAND flash. As shown in FIG. 1, BIOS 105 may implement an instance of write combined error correction and translation driver 116, in addition to (or in lieu of) the instance implemented by operating system 114.

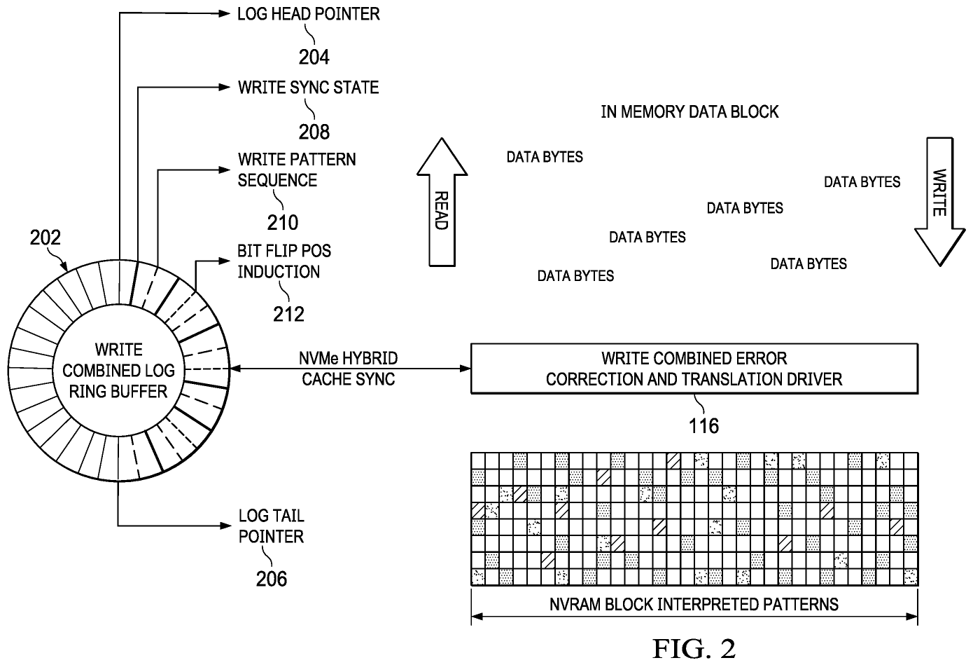

Network interface 108 may include any suitable system, apparatus, or device operable to serve as an interface between information handling system 102 and a network external to information handling system 102 (e.g., network 210 depicted in FIG. 2). Network interface 108 may allow information handling system 102 to communicate via an external network using any suitable transmission protocol and/or standard.

Generally speaking, information handling resources 120 may include any component system, device or apparatus of information handling system 102, including without limitation processors, buses, computer-readable media, input-output devices and/or interfaces, storage resources, network interfaces, motherboards, electro-mechanical devices (e.g., fans), displays, batteries, and/or power supplies.

In operation, write combined error correction and translation driver 116 may implement a write-combined logging over a single- and multi-bit ECC error recovery approach to provide faster writes for OS SMM and pre-boot access and data recovery for an NVRAM storing platform firmware (e.g., BIOS 105) of information handling system 102. Such approach may combine NVRAM write operations and a data pattern into versioned persistent logging for quick data recovery. For example, patterned matched parity bits for single- and multi-bit ECC error recovery may be utilized for accurate data recovery during boot of information handling system 102, and versioned data logging of a data pattern may enable roll back of NVRAM data. Driver 116 may also enable write data pattern matched bit flipping for optimizing asymmetric write operations to NVRAM to support OS-based SMM quick return from write operations as well as extending the lifetime of the flash device.

FIG. 2 illustrates a diagram depicting functionality of write combined error correction and translation driver 116, in accordance with embodiments of the present disclosure. As shown in FIG. 2, driver 116 may optimize every write operation to NVRAM with combined logging in a hybrid buffer 202 (e.g., a cache implemented in both random access memory and non-volatile memory) that may be implemented in the form of a ring buffer. For each NVRAM write operation, driver 116 may write information to hybrid buffer 202, then to NVRAM.

As further shown in FIG. 2, hybrid buffer 202 may include a log head pointer 204 pointing to the head of hybrid buffer 202 and a log tail pointer 206 pointing to the end of hybrid buffer 202. Driver 116 may cache every write pattern in the form of a write synchronization (sync) state 208, a write pattern sequence 210, and a bit flip position indicator 212.

Write sync state 208 may be based on NVRAM data write state and ECC correction index to take optimized data in a log area of hybrid buffer 202.

With respect to write pattern sequence 210, data patterns for write operations may be monitored based on previous write history and the most recent recoverable patterns may be synchronized for every write operation. Accordingly, an index pattern key with a data log may recover NVRAM block data to a particular time instant. Recovery of data may be 100% guaranteed as the pattern and optimized logs may include a time stamp as a hash and may be persistently logged until the same block is overwritten with new data.

With respect to bit-flip position indicator 212, driver 116 may implement within an NVRAM memory translation module integral to driver 116, a multi-bit error correction algorithm based on bit-flip position. Such algorithm may scan based on bit-flip events due to power failure or a memory refresh cycle. The data sequence of bit-flip position indicator 212 may be overlaid with a pattern-based persistent log of a particular block to retrieve the original bit at an index in order to recover flipped bits, which may guarantee recovery of flipped bits over time in NVRAM.

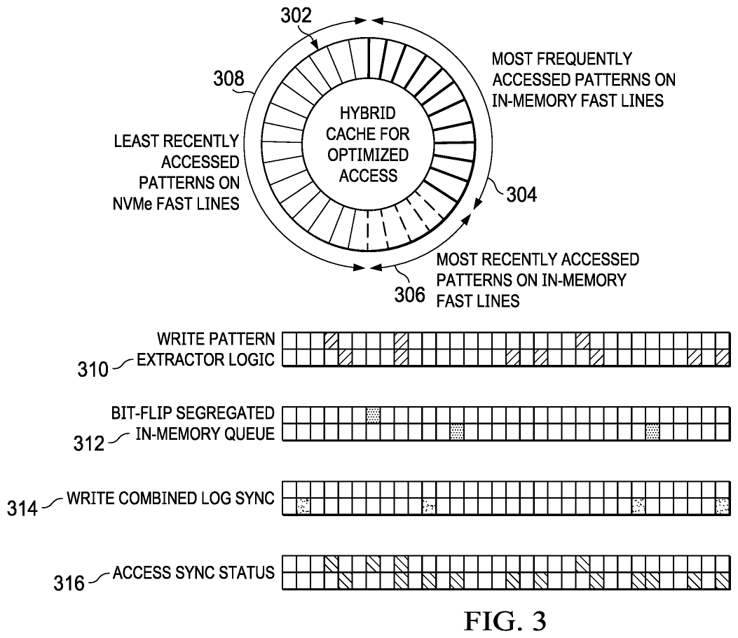

FIG. 3 illustrates a diagram depicting a hybrid cache 302, in accordance with embodiments of the present disclosure. In some embodiments, hybrid cache 302 may comprise ring cache 202, spread across non-volatile and volatile memory. Hybrid cache 302 may be implemented over a random access memory area of memory 104 extended over a non-volatile memory store with most-frequently-accessed patterns 304 and recently-accessed patterns 306 implemented in RAM indexing the write-combined logging approach of hybrid buffer 202 and least-recently accessed patterns 308 implemented in non-volatile memory.

Accordingly, driver 116 may overcome hamming code deficiency of ECC only overwrites of traditional approaches. Driver 116 may implement a pattern extractor that handles operations of NAND write operations in a write buffer for extraction logic based on bit pattern. Thus, the next time the index is fetched as shown in write pattern extractor logic 310, the pattern-based correction update may only be made to NVRAM. In FIG. 3, write pattern extractor logic 310 may indicate portions of data for which data had changed due to a write operation.

Driver 116 may also perform a bit-flip segregation within a bit-flip-segregated in-memory queue 312 for flip indexing and correction based on a write combined log synchronization (sync) 314 for a write/read operation. Bit-flip-segregated in-memory queue 312 may indicate portions of data with corrupted bits, and write combined log synchronization (sync) 314 may indicate the head of a particular word in NVRAM. Such approach may be efficient as a pattern may be known and a cache index may simplify correction for ECC or other failure scenarios.

Driver 116 may also implement an access synchronization (sync) status 316 that may implement an optimized in-memory and hybrid-based status synchronization for runtime and persistent status codes. Access sync status 316 may provide status information indicating whether an operation of driver 116 was successful for a particular block.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

1. An information handling system comprising:
a processor; and
a non-transitory computer-readable medium having stored thereon a program of instructions executable by the processor, the program of instructions configured to, when read and executed by the processor:
respond to receiving a write request to a non-volatile memory by writing information to a hybrid buffer comprising a random access memory portion and a non-volatile portion before writing information to the non-volatile memory;
combine write request data and data patterns associated with the write request into a versioned log and store the versioned log in a persistent memory; and
store in the persistent memory patterned-matched bits for single- and multi-bit error recovery code-based recovery,
optimize every write operation to NVRAM with combined logging in a hybrid buffer 202 (e.g., a cache implemented in both random access memory and non-volatile memory)

2. The information handling system of claim 1, wherein the non-volatile memory is a non-volatile random access memory for storing firmware of the information handling system.

3. The information handling system of claim 2, wherein the non-volatile random access memory is implemented with NAND flash.

4. The information handling system of claim 1, the instructions further configured to, in response to corruption of data on the non-volatile memory, recover such data based on the patterned-matched bits.

5. The information handling system of claim 1, the instructions further configured to, in response to corruption of data on the non-volatile memory, and based on the versioned log, recover a previous firmware version for booting to an operating system of the information handling system.

6. A method comprising:
respond to receiving a write request to a non-volatile memory of an information handling system by writing information to a hybrid buffer comprising a random access memory portion and a non-volatile portion before writing information to the non-volatile memory;
combining write request data and data patterns associated with the write request into a versioned log and storing the versioned log in a persistent memory; and
storing in the persistent memory patterned-matched bits for single- and multi-bit error recovery code-based recovery.

7. The method of claim 6, wherein the non-volatile memory is a non-volatile random access memory for storing firmware of the information handling system.

8. The method of claim 7, wherein the non-volatile random access memory is implemented with NAND flash.

9. The method of claim 6, further comprising, in response to corruption of data on the non-volatile memory, recovering such data based on the patterned-matched bits.

10. The method of claim 6, further comprising, in response to corruption of data on the non-volatile memory, and based on the versioned log, recovering a previous firmware version for booting to an operating system of the information handling system.

11. An article of manufacture comprising:
a non-transitory computer-readable medium; and
computer-executable instructions carried on the computer readable medium, the instructions readable by a processor, the instructions, when read and executed, for causing the processor to:
respond to receiving a write request to a non-volatile memory of an information handling system by writing information to a hybrid buffer comprising a random access memory portion and a non-volatile portion before writing information to the non-volatile memory;
combine write request data and data patterns associated with the write request into a versioned log and store the versioned log in a persistent memory; and
store in the persistent memory patterned-matched bits for single- and multi-bit error recovery code-based recovery.

12. The article of claim 11, wherein the non-volatile memory is a non-volatile random access memory for storing firmware of the information handling system.

13. The article of claim 12, wherein the non-volatile random access memory is implemented with NAND flash.

14. The article of claim 11, the instructions for further causing the processor to, in response to corruption of data on the non-volatile memory, recover such data based on the patterned-matched bits.

15. The article of claim 11, the instructions for further causing the processor to, in response to corruption of data on the non-volatile memory, and based on the versioned log, recover a previous firmware version for booting to an operating system of the information handling system.
